(19) United States
(12) Patent Application Publication
(10) Pub. No.: US 2007/0252070 A1
(43) Pub. Date: Nov. 1, 2007

(54) Base for decorative art-glass torchiere

(76) Inventor: Lyndon Pullins, Petaluma, CA (US)

Correspondence Address: Lyndon Pullins, 809 Rancho Way, Petaluma, CA, 94954, US

(21) Appl. No.: 11/643,561

(22) Filed: Mar. 29, 2007

Related U.S. Application Data
(60) Provisional application No. 60/752,938, filed on Dec. 21, 2005.

(51) Int. Cl. F16M 13/00; B23K 1/00; B43M 11/00

(52) U.S. Cl. 248/519; 156/60; 228/111.5

(57) ABSTRACT

My design and invention of the Base for Decorative Art Glass Torchiere was born by my desire to provide safe and decorative indoor or outdoor lighting using the handkerchief style vases I create. The handkerchief style vases used in my Art Glass Torchieres have been around since at least the 1960's. The durable and decorative Base created from copper and solder is functional indoors and out. Wired for electric lighting, the vase may easily be removed to change the light bulb. The holes drilled in the vase holder are to release heat radiated from the light bulb and the union washer's purpose is to be a cushion for the vase and weather proofing for the interior of the holder base.

### Disclosure of Base for Decorative Art Glass Torchiere

I, Lyndon Pullins, have invented a new design for a torchiere, as set forth in the following specifications. The claimed Base for Decorative Art Glass Torchiere is used to hold an art glass vase for decorative lighting which may be used indoors or outdoors.

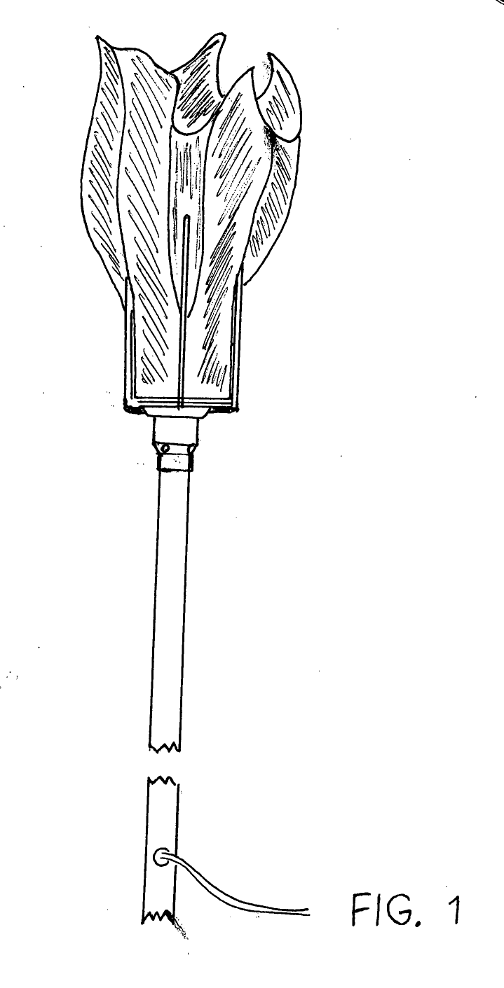

FIG. 1 is a side view of my art glass torchiere showing the design of my halogen lighted base holding an art glass vase and with the low voltage cable extending from the lower end of the post.

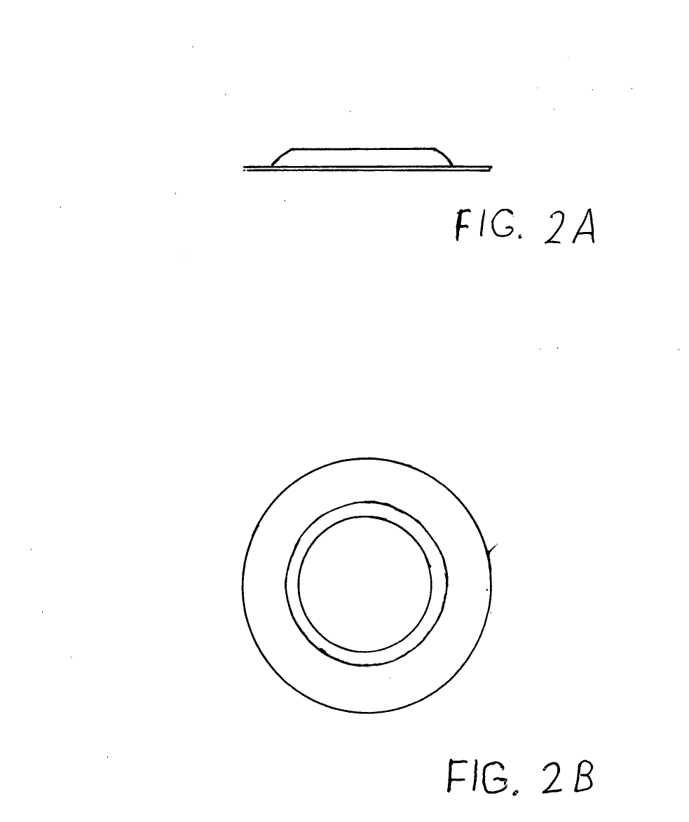

FIG. 2A is a side view of the copper faucet trimmer, the first step in constructing the vase holder assembly for the torchiere's base.

FIG. 2B is a top plan view of the copper faucet trimmer.

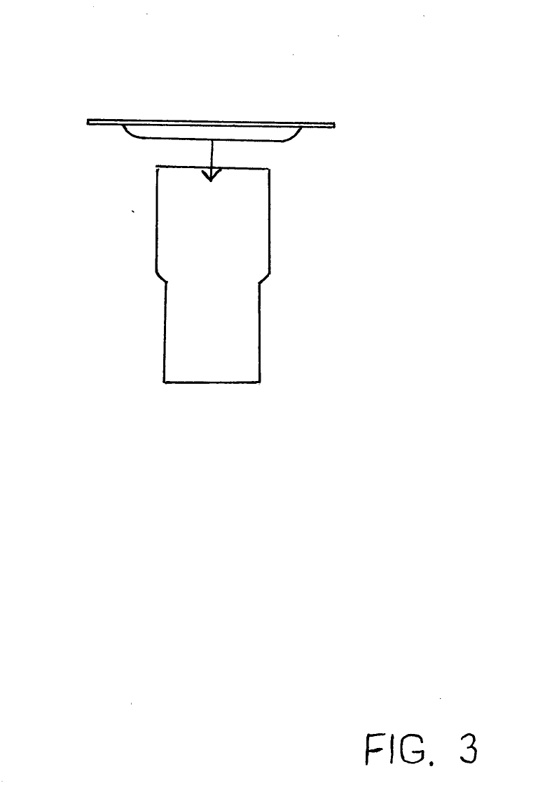

FIG. 3 is a side view on placing the faucet trimmer onto the pipe reducer.

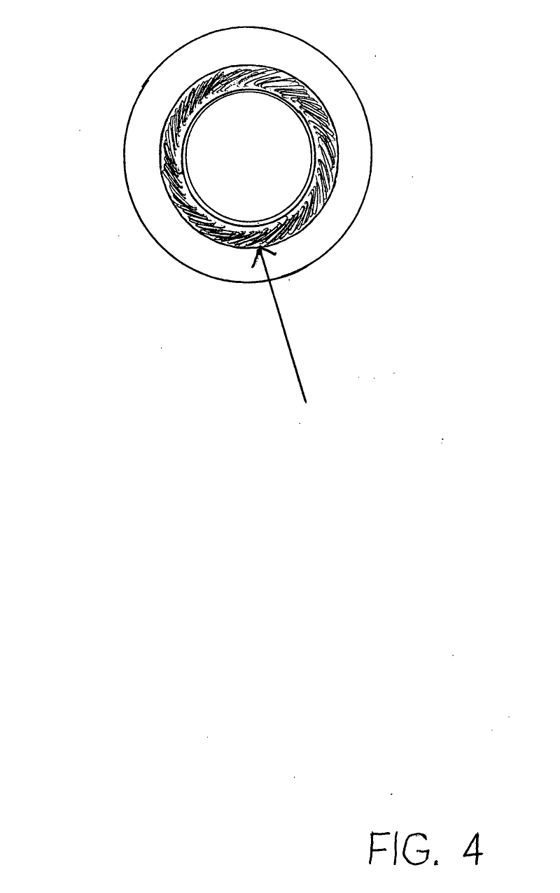

FIG. 4 is a top view of the faucet trimmer soldered to reducer.

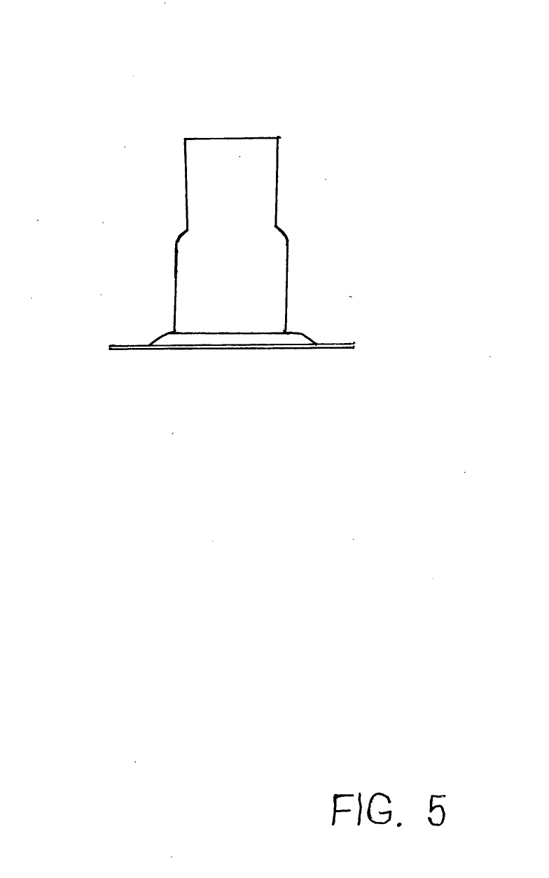

FIG. 5 is a side view of the faucet trimmer and pipe reducer turned over face down.

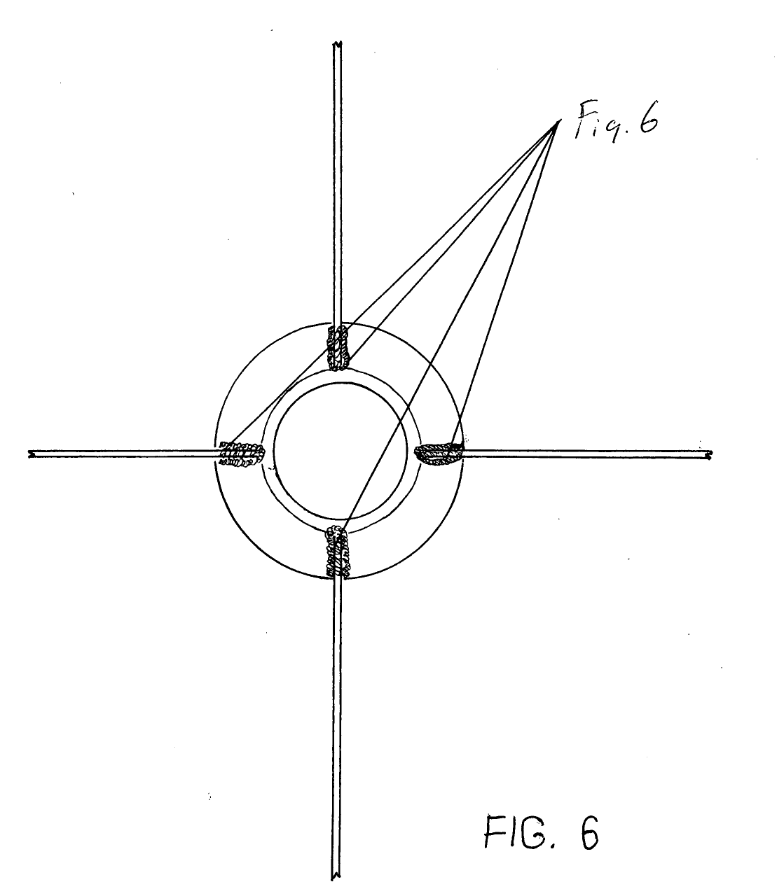

FIG. 6 is a top plan view of placing and soldering the hard copper wire to the faucet trimmer.

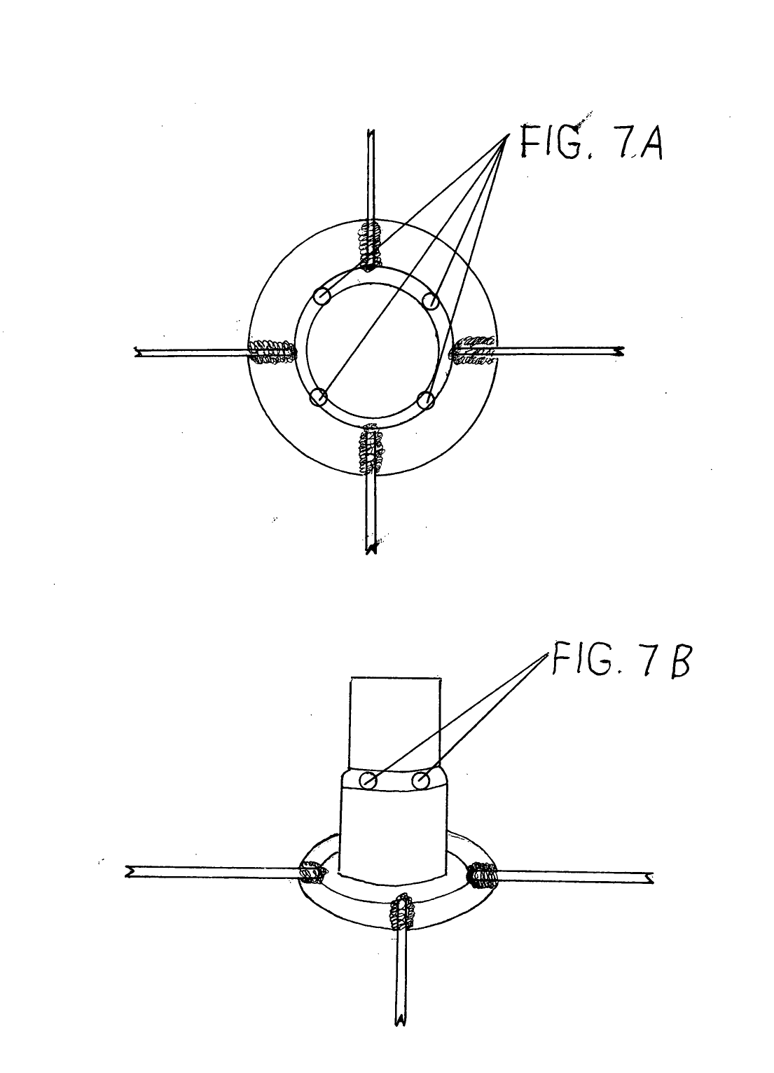

FIG. 7A is a top plan view of the location to drill holes in the pipe reducer.

FIG. 7B is a side view of the location to drill holes in the pipe reducer.

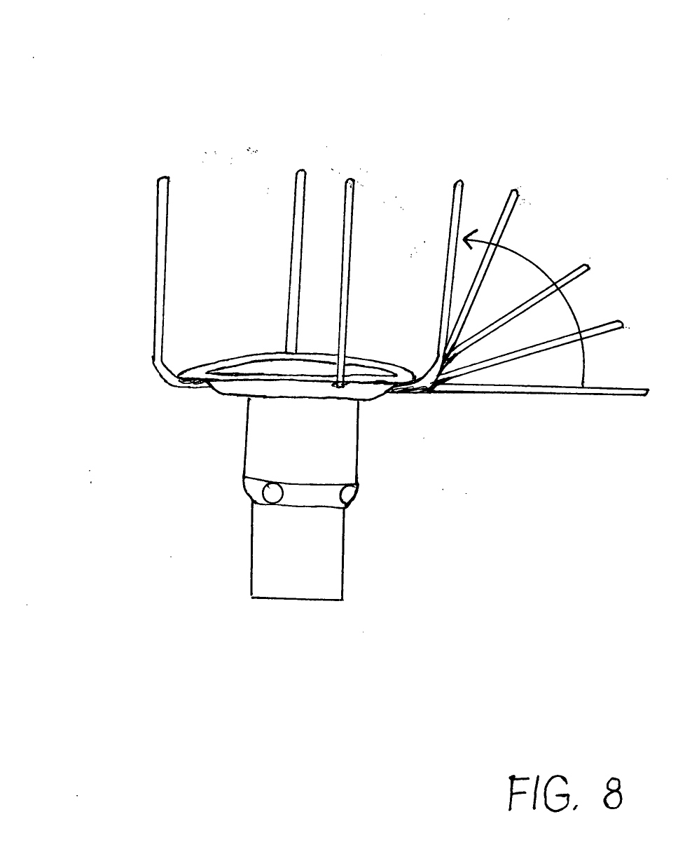

FIG. 8 is a side view of the bending of the hard wire to hold the torchiere's vase.

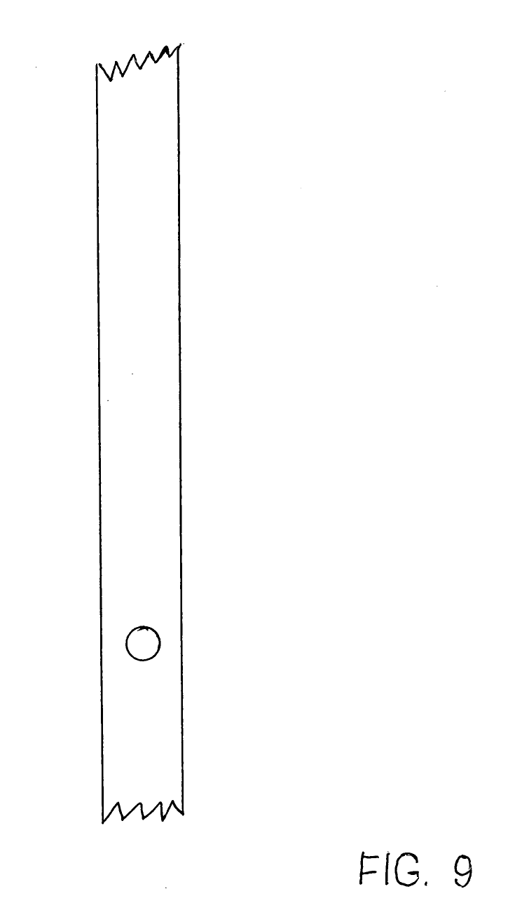

FIG. 9 is a front view of the ⅜ inch hole drilled into the copper pipe post, the first step in constructing the post assembly for the torchiere's base.

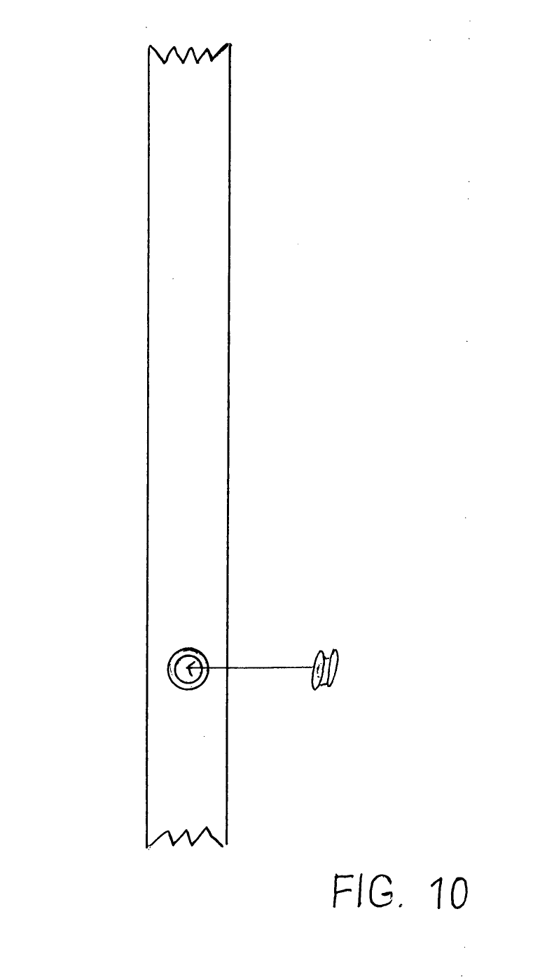

FIG. 10 is a front view of the insertion of the rubber grommet into the drilled hole.

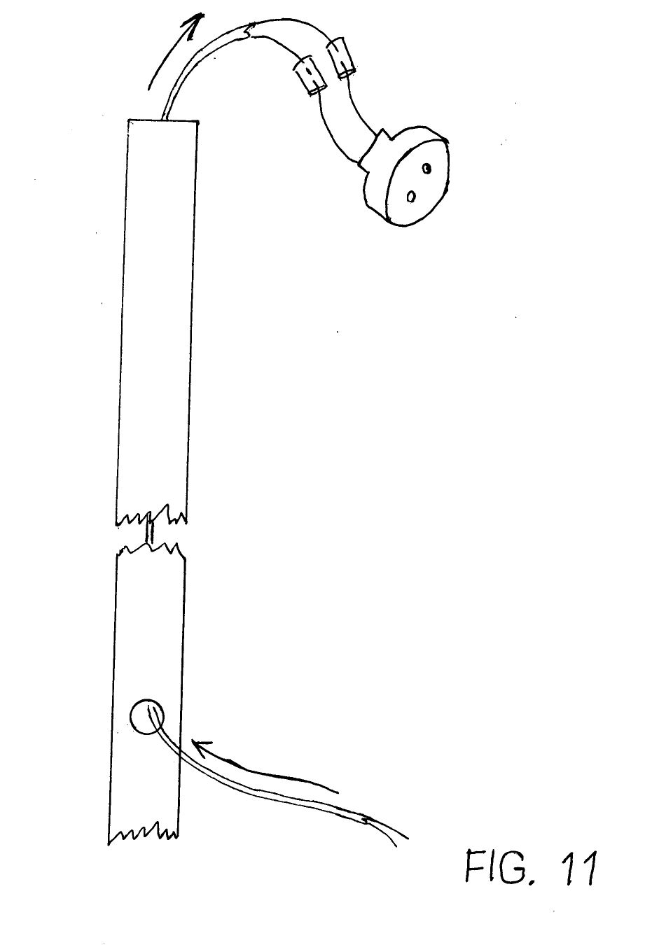

FIG. 11 is a front view of inserting and feeding the electrical cable through the post and attaching it to the socket.

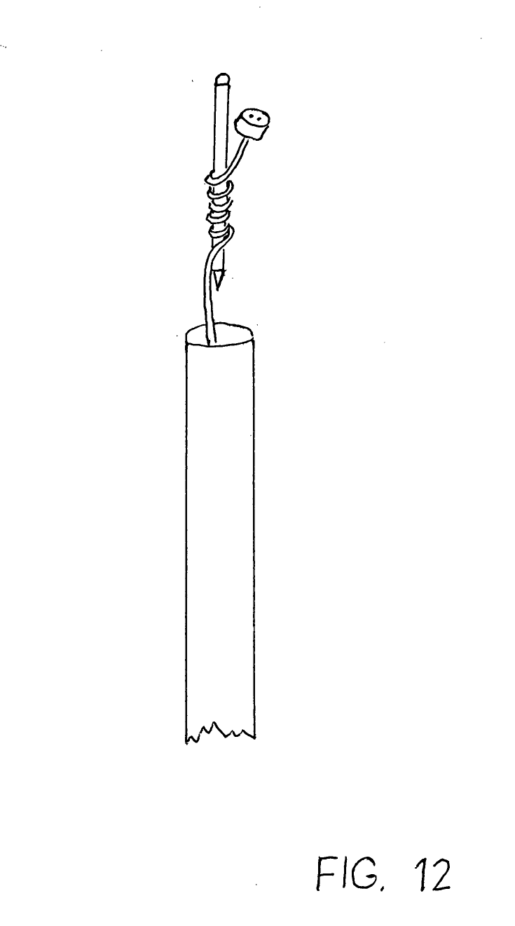

FIG. 12 is a side view of coiling the socket lead wires.

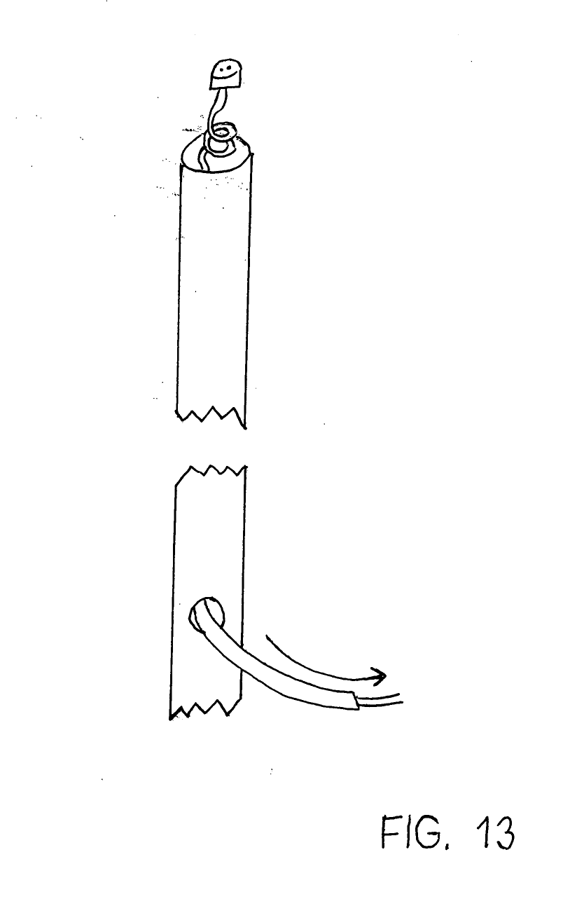

FIG. 13 is a front view of pulling the cable back through the post assembly.

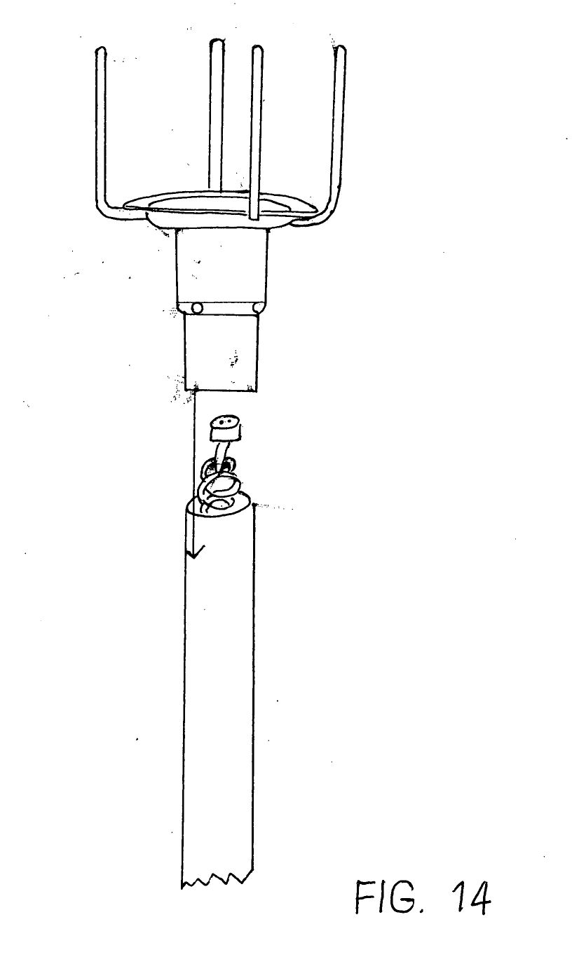

FIG. 14 is a side view of slipping the vase holder assembly onto the post assembly.

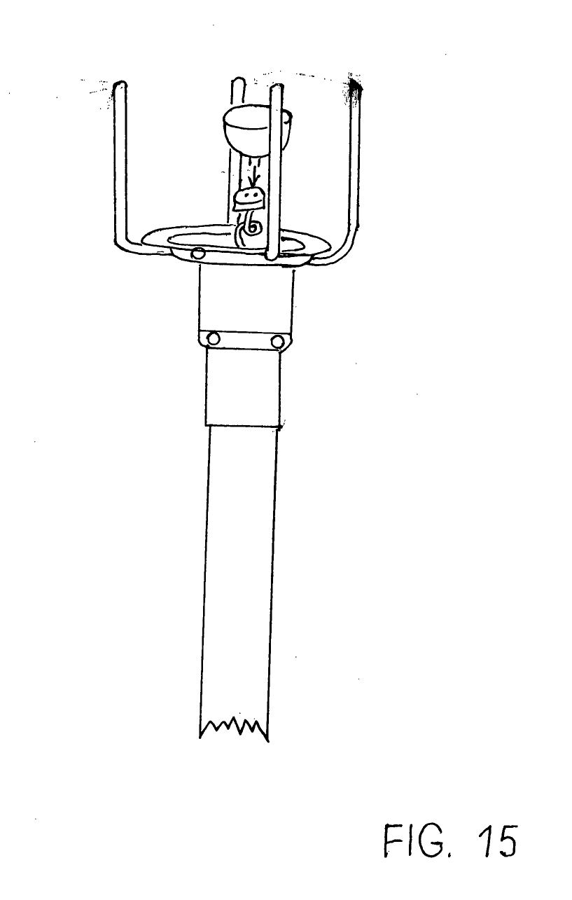

FIG. 15 is a side view of inserting an MR8 light bulb into the socket.

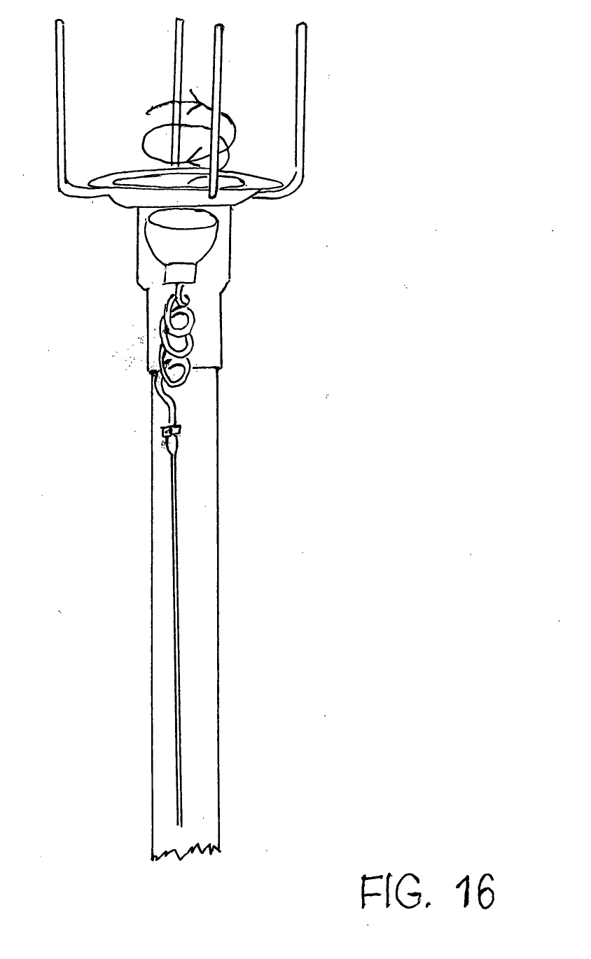

FIG. 16 is a side view above and inside the post showing how to twist and push the bulb and lead wires to below the surface of the faucet trimmer.

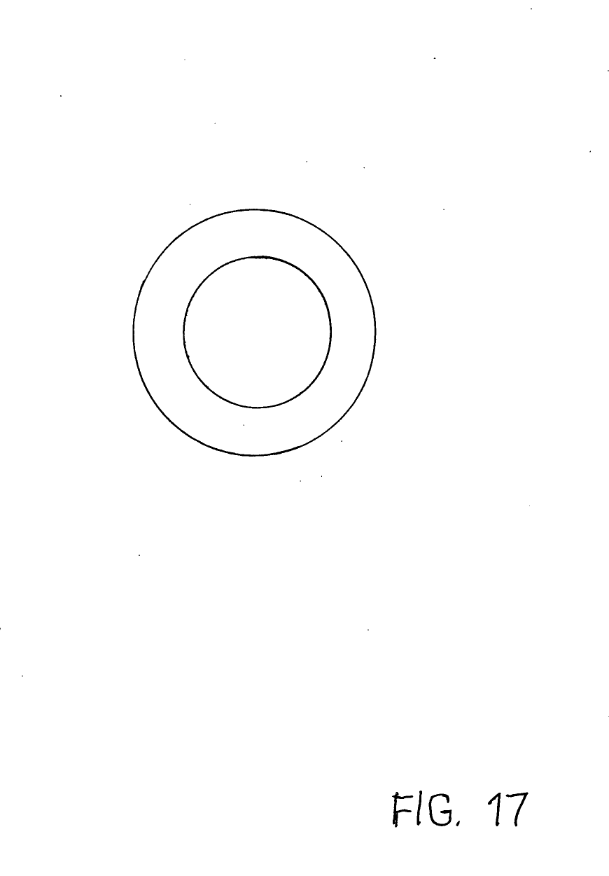

FIG. 17 is a top plan view of the rubber union washer.

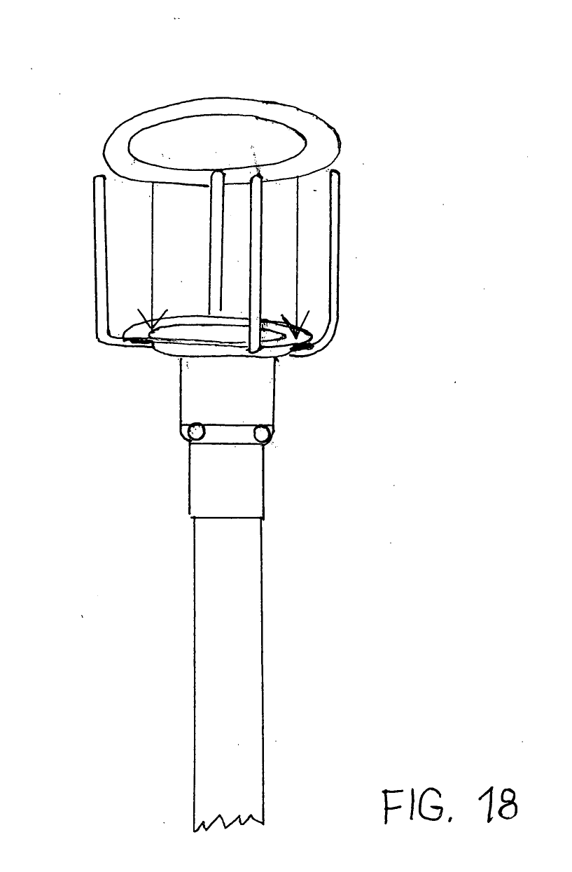

FIG. 18 is a side view of placing the union washer onto the top of the vase holder assembly surface.

I claim:

1. The design of the base of the art glass torchiere as shown.
